(19) United States
(12) Patent Application Publication
(10) Pub. No.: US 2006/0013636 A1
(43) Pub. Date: Jan. 19, 2006

(54) Pen

(76) Inventor: Shachar Shalom, Givat Shmuel (IL)

Correspondence Address: SHACHAR SHALOM, 8 BEERI ST., GIVAT SHMUEL, IL

(21) Appl. No.: 10/891,471

(22) Filed: Jul. 15, 2004

(51) Int. Cl. B43K 24/02

(52) U.S. Cl. 401/107

(57) ABSTRACT

A non ball-point pen includes integrated covers for hermetic sealing of the pen. These covers are located at the pen's writing/drawing end, and may be automatically closed and opened. This may be used for other non ball-point writing/drawing tools.

### FIELD OF THE INVENTION

This invention relates to pens, and more particularly to a non-ballpoint pen with an integrated cap for hermetically sealing the pen's tip.

### STATEMENT AS TO RIGHTS TO INVENTIONS MADE UNDER FEDERALLY SPONSORED R&D

There was no Federal sponsoring for the present invention, therefore there are no rights deriving therefrom.

### BACKGROUND OF THE INVENTION

Ball-point pens are in wide use today—they comprise just one piece, so they do not need a separate cap.

The ink of ball-point pens, however, has to be protected from drying using a ball bearing at the writing end of the pen.

Since the ink of ball-point pens is protected from drying, they do not require additional hermetic sealing, such as an additional cap.

This allows the optional use of a simple thrust mechanism which allows the ball bearing at the edge of the pen, together with the ink cartridge, to move in and out of the pen's barrel using a simple push-button mechanism with a spring between the pens body and the ink cartridge. Thus mechanism allows for easy closing and opening of the pen.

Ball-point pens, however, may have the disadvantage that they are often not comfortable—in order to write, the pen's ball bearing has to roll, requiring to operate some mechanical pressure and effort, which might cause pains in the writer's hand, over time.

A possible cause of ball-point pen's problems, such as not writing good enough, being stuck or not writing at all, might be their mechanical structure and operation, which requires both sealing of the ink and easy rotation of the ball bearing, so as not to make it too difficult to write with—possibly conflicting requirements.

Since a pressure is used on the ball bearing when writing, in time the ball-point pen might be damaged, and may cease writing properly.

Pens other than ball-point pens may be more comfortable to write with, since they often allow for using less pressure when writing and there is no ball that the pen's user should roll in order for the pen to write.

Such pens may include, for example, felt-tipped pens, fountain pens, markers, edge lighters and any ink pen with a pointed and/or fixed top instead of a mechanism with a ball at the top of the pen.

Since the ink of pens other than ball-point pens is not protected from drying, they do require additional hermetic sealing means, such as an additional cap.

This cap is often not comfortable since, each time a person wishes to write, a storage place for the cap would be required. Placing the cap on the back of the pen would make the pen heavier and harder to maneuver while writing. Placing the cap in some other place might cause its loss, in which case the pen remains without a cap, so it might dry or leave stains.

In addition, the usage of two hands is necessary to remove the cap, thus the pen requires more attention. This is sometimes not comfortable, for example when the user desires to open the pen while talking on the phone.

This is unlike the ball-point pen with the simple push button, which can be easily operated, opened and closed, all using just one hand.

The simple push button mechanism of ball-point pens cannot be used with the other pens, however, since it does not provide for hermetically sealing the pen.

In summary, the use of ball-point pens might be simpler and faster, just to push a button and to write, all using one hand. However, because of the ball bearing, it may require more effort for writing. Sometimes, the pen does not write well and eventually breaks down.

The use of pens other than ball-point pens is more complex, requiring the use of two hands, in order to open or close the pen and there is a problem with cap placement and keeping, while writing.

However it may write better and requires less effort while writing.

### SUMMARY OF THE INVENTION

The present disclosure relates to improvements in pens other than ball-point pens.

The new pen has an integrated cap for hermetic sealing of the pen, instead of a separable part cap such as used today, in those pens.

The new pen, similarly to ball-point pens, can be used in a simpler and faster manner, because it can be opened and closed just by button pushing, such as with the thumb.

Thus, writing and using the new pen can all be done by one hand.

The new pen has also the advantages of non ball-point pens, such as ease of writing with, since these pens often allow for using less pressure when writing and there is no ball that the user should roll in order for the pen to write.

With the new pen, there is no problem of a cap placement and keeping, since it is an integral part of the pen, and remains connected to the pen.

The integrated cap may be relatively small and lightweight, only covering a small opening for the pen's point or nib.

Thus, the cap's weight does not bother the user while using the new pen. This may not be true for pens with a massive cap which is placed on the barrel while writing and its weight is significant.

The new pen uses a novel structure, so that when the pen is closed the inner parts which include the ink cartridge and the point or nib are protected within the barrel of the pen, with the cap closed which makes the inner parts hermetically sealed.

When the new pen's button is pressed, the cap, which may be just a cover with a spring, is opened, and the inner device is pushed outside so that the pen can write without the need to take care of the cap.

When the new pen's button is pressed again, the inner parts return back into the new pens barrel, the cap is closed, and the ink and inner parts of the pen are protected and hermetically sealed again.

### BRIEF DESCRIPTION OF THE DRAWINGS

FIG. 1 illustrates the new pen in its closed state, with one vertical opening cap.

FIG. 2 illustrates the new pen in its opened state, with two vertical opening caps.

FIG. 3 illustrates the new pen in its opened state, with one horizontal opening cap.

### DETAILED DESCRIPTION OF THE PREFERRED EMBODIMENTS

A preferred embodiment of the present invention will now be described by way of example and with reference to the accompanying drawings.

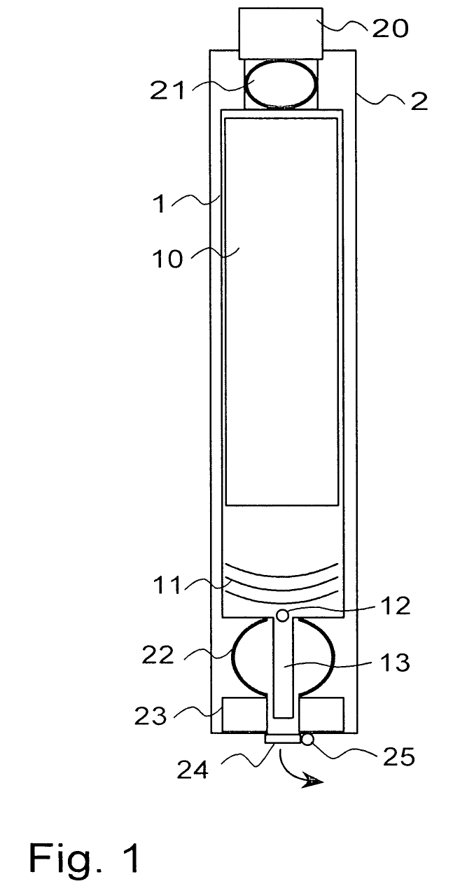

FIG. 1 illustrates the new pen in its closed state, with one vertical opening cap.

The pen comprises a barrel 2, which holds the components together and may be sealed, except for the opening at the bottom. This barrel can be similar to that of any other pen or writing/drawing tool.

A button mechanism 20 allows the opening and closing of the new pen.

This button mechanism may be implemented by push-button mechanism, thus the new pen will be opened/closed by pushing this button.

The button mechanism 20 may be implemented also by a rotating button, or any other possible form which will open and close the new pen.

A thrust mechanism 21 is responsible for pushing down the internal parts 1, in order to open the pen, or to be folded, so that the pen would be closed. The thrust mechanism may include mechanical parts such as springs, and is connected to the button mechanism, on its other side.

The internal parts 1, include the ink cartridge 10, filter 11, a ventilation opening 12, a narrow tube with a point/nib at its end 13, through which the ink is flowing out.

When the pen is closed, the filter, ventilation opening, and other internal parts are sealed within the barrel, so that the ink does not dry up.

A ventilation opening 12 is required in order to allow air get inside the pen instead of the ink that is flowing out through the tube 13.

The ventilation opening may be part of the tube 13, or connected to the tube.

The filter 11 is optional, and may be the same as in pens today.

One or more springs 22, are connected between the barrel 2 and the internal parts 1, and responsible for pushing the internal parts up, when closing is required.

The springs may be connected to the button mechanism, or may be independent, thus pressing the internal parts up all the time.

The springs 22 may be implemented by other means as well, which will press the internal parts 1 upwards.

A cup 23 is responsible for hermetically sealing the area between the barrel 2 and the opening cap 24.

A hinge and/or other means 25, are responsible for opening and closing the opening cap 24, so that when writing is required and the button is pushed the opening cap will be opened, and when writing is completed and the button is pushed again, the opening cap will be closed, and the pen is sealed at its writing end, and is sealed altogether.

The hinge means 25 and the opening cap 24 may be connected to the button by other means, or may be moved by the tube 13 directly.

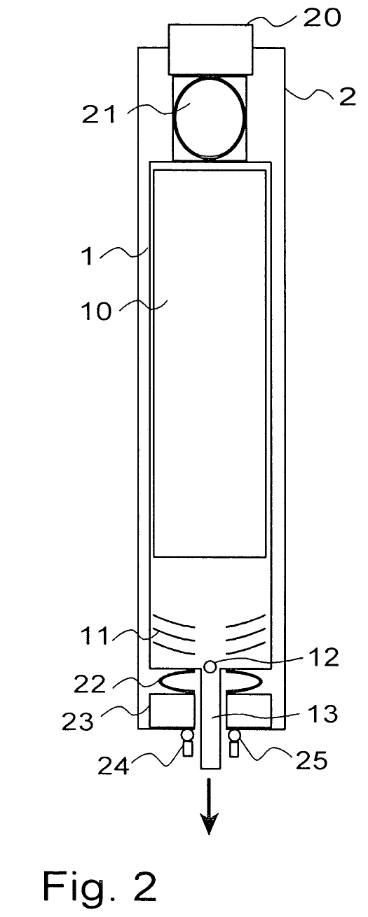

FIG. 2 illustrates the new pen opened, with two vertical opening caps.

The opening cap and hinge may include spring and other means, so that, when the tube 13 is lifted, the opening will be automatically closed.

There may be more than one hinge 25 and more than one opening cap 24.

The opening cap can be opened in various directions and by using various methods. In one embodiment, there is just one opening cap, whereas in another embodiment there may be two opening caps 24, so that each one is smaller in size, and may be less interfering. More than two such openings may be used.

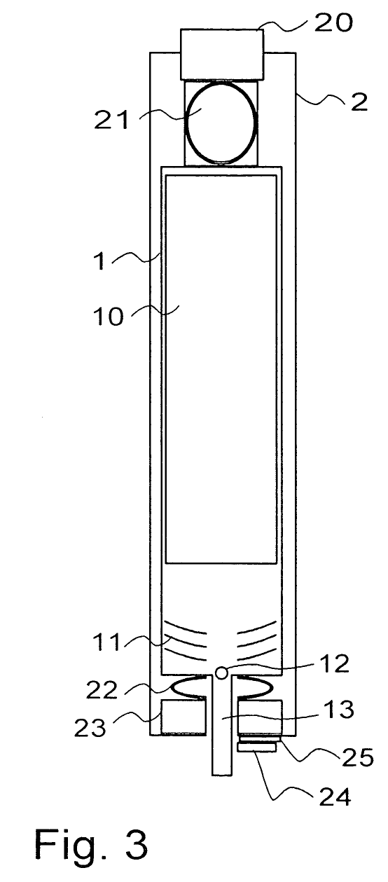

FIG. 3 illustrates the new pen opened, with one horizontal opening cap. In another embodiment the opening cap 24 is opened to the side, such as with a track.

In this way, sealing might be better and the opening cap is less interfering. The hinge 25 in this embodiment may be a track in which the opening cap slides.

A similar mechanism may be implemented for writing/drawing tools other than ball-point pens, this including for example felt-tipped pens, fountain pens, markers, edge lighters and any ink pen with a pointed and/or fixed top instead of a mechanism with a ball at the top of the writing/drawing tool.

Similar mechanism may be implemented for non-ink writing/drawing tools, such as handing/ writing tools which use gel, white board markers, etc.

Another possible implementation would allow the tube 13 to move out of the barrel, while the ink cartridge remains at a fixed place relative to the barrel. In this way the ink cartridge may be part of the barrel.

In one embodiment, the tube 13 (the writing tip) opens the sealing means (opening cap) 24 by pushing it out of the way (sideways or down, for example) when the tube 13 is pushed out for writing.

In another embodiment, a separate mechanism is used to manually or automatically open and close the sealing means 24.

Another possible implementation would include the tube and the ink cartridge remaining at a fixed place relative to the barrel, and the opening cap would uncover the edge of the tube, so that it will be possible to write/draw when opened. In this way the ink cartridge and the tube may be part of the barrel.

In another embodiment, the opening cap 24 is opened and/or closed manually, this is done separately from pushing the button.

In another embodiment the button mechanism is not on the top of the pen. The button mechanism may be on the side of the pen, for instance.

Various other means may be used for sealing the pen's tip, for example a flexible partition possibly made of rubber, a ball or other sealing means.

What is claimed is:

1. A writing and/or drawing tool, other than ball-point type, further including means for sealing the tool at its writing end, these means including one or more integral moving parts of the writing and/or drawing tool, and wherein the sealing means remain connected to the tool while writing and/or drawing.

2. The writing and/or drawing tool according to claim 1, wherein a button mechanism is included, so that it is possible to open and close the tool by using the button.

3. The writing and/or drawing tool according to claim 2, wherein the sealing means include means for opening and closing the tools sealing means manually.

4. The writing and/or drawing tool according to claim 2, wherein the sealing means are not connected to the button mechanism, but when the button is used in order to open the tool, inner parts move out and open the sealing means; When the button is used in order to close the tool, inner parts move into the tool and the sealing means are closed automatically.

5. The writing and/or drawing tool according to claim 2, wherein the sealing means are connected to the button mechanism by other means, when the button is used in order to open the tool, other means move and open the sealing means; When the button is used in order to close the tool, the other means return to their original position, the sealing means are closed automatically or by the other means.

6. The writing and/or drawing tool according to claim 2, wherein internal parts are connected to the tools barrel, and the tool is closed or opened by moving the sealing means.

7. The writing and/or drawing tool according to claim 2, wherein internal parts are connected together, and can move out, as one piece, of the writing and/or drawing tool.

8. The writing and/or drawing tool according to claim 2, wherein ink or other fluid cartridge is at a fixed location relative to tools barrel, but some other parts which deliver writing/drawing fluid out, can move in and out of the writing and/or drawing tool.
